(19) United States
(12) Patent Application Publication
(10) Pub. No.: US 2024/0383739 A1
(43) Pub. Date: Nov. 21, 2024

(54) TREATMENT SYSTEM FOR KEGS

(71) Applicant: KHS GMBH, Dortmund (DE)

(72) Inventors: Volker Damerow, Uelversheim (DE); Sebastian Eckes, Langenlonsheim (DE); Maximilian Weindorf, Münsterappel (DE); Christian Pedersen, Kriftel (DE); Manfred Wahl, Oberwiesen (DE); Andreas Weber, Bad Sobernheim (DE); Olaf Muszinski, Bad Soden (DE)

(21) Appl. No.: 18/687,960

(22) PCT Filed: Aug. 30, 2022
(86) PCT No.: PCT/EP2022/074058

§ 371 Date: Feb. 29, 2024

(30) Foreign Application Priority Data
Aug. 31, 2021 (DE) 10 2021 122 454.3

(51) Int. Cl. B67C 3/28; B67C 3/30; B67C 7/00

(52) U.S. Cl. CPC B67C 3/28; B67C 3/30; B67C 7/00

(57) ABSTRACT

A system for treating kegs with at least two treatment modules. Each treatment module has a keg receiving area, a treatment head, and an interface. The system contains a controller for controlling the treatment modules. At least one of the treatment modules is connected to a filling product source, which provides a first filling product, via the respective interface of the treatment module. At least one other treatment module of the treatment modules is connected to a filling product source, which provides a second filling product, via the respective interface of the treatment module. The controller is designed to actuate the treatment modules for a simultaneous and/or a delayed filling process for different filling products.

The present invention relates to a system for treating kegs, in particular cleaning and filling, with at least two treatment modules and a controller for controlling the treatment modules.

A system for treating kegs with several treatment stations is known, for example, from the printed publication WO 015/090888 A1.

The trend at present is increasingly towards the diversification of types of beverage, in particular with smaller beverage fillers, such as breweries. For example, among beers there are a variety of craft beers or beers with different fruit admixtures, while in the soft drink sector there is an ever increasing selection of different flavour substances and sweetening agents.

From this the need frequently arises of converting the treatment system from one filling product to another filling product. The frequent changeover of the treatment system to another filling product is time-consuming. Particularly when smaller batches of products are to be filled, this leads to a frequent changeover of the system and the corresponding down times, which reduce the effectiveness of the system as a whole.

The object of the present invention is to provide a keg treatment system which is flexible and which allows for an effective filling of kegs even in smaller quantities.

This object is solved by a system in accordance with claim 1. Advantageous further embodiments of the invention are the objects of the subclaims. Advantageous embodiments and further developments of the invention are likewise described in the further description and represented in the drawings.

The system according to the invention for the treatment of kegs comprises at least two treatment modules, each of which comprises a keg receiver for receiving at least one keg during the treatment, a treatment head for filling the kegs, and at least one interface for a discharge and for at least one filling product line as well as for at least one cleaning medium line. The system also comprises a controller for controlling the treatment modules. At least one of the treatment modules is connected via an interface to a filling product source which provides a first filling product, and at least one other of the treatment modules is connected via its interface to a filling product source which provides a second filling product, wherein the first filling product differs from the second filling product. The controller is configured such as to actuate and control the treatment modules for the simultaneous and/or time-offset filling with different filling products.

With the system according to the invention, which in this situation can also be designated as a treatment system, it is possible in this way for different filling products to be filled on one system while overlapping in time, and without the need for the treatment modules to be changed. The possibility of filling different filling products on one system while overlapping in time leads to greater flexibility, since, when filling a product with a small throughput, the entire system is not occupied by this filling product, and no re-equipping of the treatment modules for another filling product is required.

The filling product source is preferably a filling product tank, but can also be provided by means of a filling product line connected to a filling product store of any desired configuration.

A “filling product” in the meaning of the present invention can be, for example, a beverage, in particular a beverage containing CO₂. For example, the filling product can be beer, a mixed beer beverage, or a carbonated soft drink.

The interface provided for each treatment module can in this situation also be designated as a supply interface, by means of which essentially the supply connections of the treatment modules are put into effect and therefore the supply with filling product and other media is ensured. The interface or supply interface in the meaning of the invention is therefore also to be understood as an interface for the supply of the treatment modules with all the fluid or gaseous media which are required for the treatment of the kegs. It is understood that in this situation the interface is equipped with connections to the corresponding lines which convey the media referred to. Such connections can in this situation also be designated as a “filling product connection” or “media connection”, and, in particular, also as “water connection”, “cleaning media connection”, or “flushing gas or tension gas connection”. The interface can preferably comprise, for example, an arrangement of several valves which can be controlled and switched, such as a valve block, wherein the individual valves can preferably be switched by means of the controller.

As “cleaning medium”, consideration can be given to all media used in the sector of the food industry, in particular the beverage industry, usually in connection with a cleaning process, which are conventionally known to the person skilled in the art. The cleaning can comprise several different cleaning steps with different cleaning media, wherein the several cleaning steps are carried out, for example, sequentially or one after another. Preferably, for the cleaning of the kegs at least one alkali is used as a cleaning medium or as a constituent of a cleaning medium.

Advantageously, the respective cleaning module is configured as a “stand-alone” module, i.e. a treatment module which can be operated independently of the other treatment modules of the system. As a result, with regard to the number of the treatment modules, a high degree of flexibility of the system can be achieved, both with regard to the total number of treatment modules of the system, which can be increased or reduced as desired, as well as with regard to the number of treatment modules which are in operation at one particular time.

Preferably, the treatment system comprises a loading device, connected to the controller, for delivering and removing the kegs to and from the treatment modules, in particular a loading robot. The delivery of the kegs, which may be equipped for different filling products, to the correctly assigned treatment modules for the corresponding product can therefore take place automatically, and is therefore optimised and reliable. For particular preference, the loading device can be a jointed-arm robot, and in particular a 5-axis or 6-axis folding-arm robot.

As an alternative, the loading device can also be a manually operated lifting aid with a display, which is connected to the controller. In this case, the operator is instructed by way of the display as to which keg is to be delivered to which treatment module.

The loading device is advantageously configured such as to be movable, and positioned in such a way that the loading device can deliver the kegs to any of the treatment modules and/or remove them from any of the treatment modules.

Preferably, the controller is configured such as to control the loading device in such a way that it moves kegs filled with different filling products out of the treatment modules and onto a transport pallet or a transporter. In this way, automatically mixed pallets can be prepared for end customers which will then no longer need to be assembled by the deliverer.

Preferably, the controller is provided with a work plan memory for orders for filling which are to be carried out, and the controller comprises a computing module which is configured such as to control both the signalling device and the loading robot on the basis of these orders for filling. In this way, the treatment system can also reliably deal even with smaller orders for filling one after another, wherein this procedure can be optimised by technical handling means. The system is therefore particularly suitable for filling smaller batches of kegs with different products.

In this situation, the computer module of the controller is configured in particular such as to control the treatment modules as well as the loading device in such a way that the processing of orders runs either time-optimised, optimised with regard to filling and/or cleaning capacity, energy-optimised, or optimised in respect of the actuation paths of the robots. It is of course also possible for these optimisation criteria to be combined together in any desired manner, such as by a corresponding costs function.

Preferably, the keg receiver is formed at least at one of the treatment modules, and preferably at several or each of the treatment modules, for receiving an individual keg. In this situation, in particular, the respective treatment module configured such as to receive an individual keg comprises exactly one keg receiver, such that the treatment module is configured to receive exactly one keg. The treatment module is therefore also to be regarded as a modular treatment station, and in particular as independent, for exactly one individual keg in each case. This has the advantage, particularly with smaller systems, that individual kegs can be filled one behind another with different products. The flexibility of such a system is therefore greater than with conventional market solutions, since the type of treatment can be changed with each keg.

Preferably, the treatment modules are configured for the treatment of different kegs, wherein at least one of the treatment modules is configured for the treatment of kegs of a first type and/or of a first size, and at least one other of the treatment modules is configured for the treatment of kegs of a second type and/or of a second size. In this way, not only can different filling products be treated in the treatment system, but also different keg sizes or keg shapes.

In one advantageous further embodiment of the invention, at least one treatment module, and preferably several or each of the treatment modules, is configured for the cleaning and filling of the kegs, and has a treatment head for both the interior cleaning as well as for filling the keg. As a result, with regard to allocation to different treatment steps, such as cleaning or filling, the system is more flexible than the prior art. Preferably, several treatment modules, and for greatest preference all the treatment modules, have this capability of cleaning a keg as well as filling it.

In this way, the system is capable of simultaneously assigning different treatment tasks, such as cleaning and filling, to the different modules in a flexible and individual manner. By contrast with the prior art, where the cleaning and filling capacity was determined by the specialised treatment modules, namely filling modules and cleaning modules, with the treatment system according to the invention an entirely flexible allocation from 100% cleaning to 100% filling is possible, depending on the control actuation of the individual modules. As well as this, it is possible for different products to be filled on different treatment modules, and for the cleaning time for each keg to be varied depending on the degree of dirt contamination.

In the treatment modules with a treatment head configured in the form of a combined cleaning and filling head, which in this situation can also be understood as a combination head, the keg which is to be treated is received in the same treatment module throughout the entire treatment, namely both during the interior cleaning as well as during the filling, and connected to the exactly one treatment head provided there. In particular, therefore, in one respective treatment module, one individual keg, exactly one, is received over the entire duration of the treatment, namely for the entire treatment process, and coupled to the treatment head.

In an advantageous further configuration of the invention, each treatment module which is suitable for cleaning has interfaces to a water line/water vapour or steam line, a tension gas line, and at least one cleaning medium line. In this way, all conventional cleaning means can be conveyed to each treatment module which are necessary for a thorough interior cleaning of the keg.

Preferably, at least one of the treatment modules has a device for the exterior cleaning of the kegs. The flexibility of this at least one treatment module is thereby extended from the treatment type of filling, and the two treatment types of filling and interior cleaning, to the treatment type of exterior cleaning, which again increases the flexibility of the system as a whole, and makes redundant the provision of separate exterior cleaning modules. The treatment modules in the treatment system are therefore preferably all configured as identical.

As an alternative or in addition, it is also possible for at least one specialised exterior cleaning module to be provided additionally to the treatment modules, which is configured solely for the exterior cleaning of one or more kegs. The exterior cleaning module is of course also arranged in the access range of the loading device for the delivery and removal of kegs to and from the exterior cleaning module. The loading device can therefore, as an alternative, load a treatment module for filling and interior cleaning, or an exterior cleaning module for the exterior cleaning of the kegs, wherein the controller can control these container treatment types in an optimum manner. The exterior cleaning procedure can additionally be displayed to an operator by a signalling device, if a loading robot is not being used.

Preferably, at least one of the treatment modules contains a temperature detection device, which is configured such as to measure an outside wall temperature of the keg during the filling and/or cleaning of the keg, in order, for example, to detect the degree of filling and/or the dirt contamination of a keg.

Preferably, the keg receiver of the treatment module is configured for the static reception of the keg, both during the cleaning as well as during the filling, which ensures simple handling.

Preferably, the treatment system contains at least one signalling device for the signalling of activities which are to be carried out in connection with the treatment modules, and the controller is configured for the controlling of the signalling device.

The signalling device can comprise a display, a visual device such as an LED, and/or an audible device, such as a loudspeaker, a buzzer, or the like. The signalling device can also be a server-based terminal device. The signalling device serves to prompt the operator person to carry out a specific activity on the treatment module (for example by issuing treatment instructions) or signalling these. In this case, instead of an automatic loading device for delivering and removing the kegs, only one instruction is issued for the manual work of an operator, supported by a loading device configured as a lifting aid which can be manually operated. Preferably, the controller is a common control device, which is in communication connection with several, and preferably all, the treatment modules, as well as with the signalling device and/or the loading robot, and is configured such as to control the units connected to it, in particular in a co-ordinated and/or process-optimised manner.

According to one particularly preferred embodiment, at least one identification device, connected to the controller, is also provided for the identification of the kegs which are to be treated. The identification device is preferably configured such as to read out information which has been stored on data carriers which are assigned to the kegs which are to be treated. In this case, the controller is preferably configured to control the system as a dependency of the information read out by the identification device. Particular advantages are derived from this, since a correct and, in particular, effective control of the system can be optimised with an embodiment variant of this type. This optimisation of the controller is possible in this situation in particular due to the fact that the optimisation process is based on the respective information which pertains to the individual keg which is to be treated. This information is deposited in this situation on data carriers which are formed, for example, by transponders, which are arranged, for example, at or in a respective keg. In this case, each data carrier or transponder is assigned directly to a respective keg.

As an alternative, it is also conceivable for the data carriers or transponders to be located at a packing or storage unit, for example on a pallet, if preferably kegs preferably of the same kind are stored there. This indirect assignment of the data carriers or transponders to the respective kegs can be particularly advantageous if the information relevant to control and concerning the respective kegs is the same for all the kegs located on the packing or storage unit. In the latter case, for example, there is accordingly the further advantage that only one data carrier for several kegs needs to be read out on the pallet.

As well as the transponders, which have already been referred to as advantageous, such as RFID transponders, it is also possible for other appropriate coding systems to form a respective data carrier, provided that compatibility can be ensured with the identification device provided. For example, it is also possible to use as data carriers barcodes, QR codes, colour coding (in particular, coloured identification markings on the kegs and/or differently coloured kegs), electronic product codes, or also printed tags or labels. It is understood that in such cases the identification device can then for example comprise, in concordance with the respective data carrier which is to be read out, a camera for the identification of the keg on the basis of image recognition or a barcode or QR code reader, or an RFID reader.

The controlled actuation of the treatment modules is preferably optimised in relation to their application, and in this situation can take place on the basis of the assignment of individual or different criteria or parameters. The optimisation takes place, for example, in respect of one or more criteria which are obtained in particular from the information which has been read out and provided to the controller. The criteria and parameters, namely the optimisation parameters or criteria, can in this situation comprise, for example: The assignment of cleaning parameters for the cleaning of the identified kegs, the assignment of filling parameters for the filling of the identified kegs, the assignment of the origin and/or further destination of the identified kegs, for example also in reference to a packing or storage unit, and/or in relation to a label identification.

Hereinafter, by way of example on the basis of a non-conclusive listing, a selection of information and data is provided, which are preferably read out, and on the basis of which (alone or in combination) the controlling of the treatment modules and of the system is optimised during the cleaning and filling processes which are to be carried out.

This data can comprise:
a) The keg type (reusable or disposable)
b) Keg dimensions and size (this may be relevant to the gripping device of the loading device and/or, if necessary, for an adjustment of the exterior cleaning)
c) Fitting type (basket, flat, draft)
d) Rated volume (20 I, 30 I, etc.) for the filling and adjusted cleaning)
e) Date of the last cleaning or date of return from the customer (for the possible adjustment of an individual cleaning time)
f) Last product contents (relevant to the interior cleaning, since individual cleaning steps of the cleaning process may differ depending on the last filling product, and also relevant for filling, in order, for example, to avoid undesirable taste changes)
g) Day of the last overhaul/repair/maintenance (retighten fitting, replace seals, etc.)
h) Cleaning times and temperatures, and media used
i) Assignment to a pallet, assignment to a customer, assignment to an order number
j) Specific filling parameters (gross weight, tare weight, filling quantity, MHB, etc.)

For particular preference, the identification device is a reader device which comprises at least one reader unit, which is configured such as to read out information stored on the data carriers with the aid of electromagnetic waves. The reader device can in particular be an RFID reader device. It is understood that, in this preferred embodiment variant, the data carriers assigned to the respective kegs are configured in the form of RFID transponders. Such RFID transponders are known to the person skilled in the art in respect of their technical configuration and function, in particular with regard to the basic structural and functional arrangement.

By the use of an RFID transponder as a data carrier in interaction with an RFID reader device, particular advantages are derived, since on the one hand contactless data exchange is possible, and, on the other, a broad application spectrum is included. For example, different frequency ranges can be used for the data exchange, in particular low frequency; LF, high frequency; HF, or ultra high frequency; UHF. In this situation, mixtures in the frequency range are also possible.

In addition to this, with the RFID system referred to, the information and data deposited can either be stored directly on the RFID transponder itself, namely stored in particular on its chip, or also in a databank which communicates with the transponder.

For particular preference, the reader device comprises several reader units, wherein in each case a reader unit of the reader device is arranged at or in at least one treatment module, and preferably at or in several treatment modules. Preferably, one or more reader units of the reader device are arranged at the loading device, for example on an arm of the loading robot. Likewise for preference, one of the several reader units can be arranged at a pallet offloading device provided in the region of the keg delivery, and/or in the region of a pallet loading device in the region of the keg discharge. As an alternative or in addition, at least one or more, and in particular all, of the treatment modules can be equipped with a reader unit of the reader device. It is therefore possible for several reader units of the reader device to be provided in the system as a whole, wherein the number of the reader units can also exceed the number of the treatment modules.

In addition to this, it is also possible, for example, for the information deposited on the data carriers to be already read out while the kegs are being delivered or loaded and/or while the kegs are in the treatment module(s) and/or while the kegs are being discharged.

According to one particularly preferred embodiment variant, the reader device is configured as a combined writing and reader device, and is arranged such as to write information onto the data carriers and/or into a databank. For example, in this way, after the treatment in the respective treatment module, information provided by the controller can be written onto the data carriers and/or into the databank communicating with it. In this situation, it is possible in particular for the information which was previously deposited on the data carriers and/or in the databank, to be at least partially overwritten.

The controller provided in the system is preferably a memory-programmable controller. It is understood that the identification device, which is in communicating connection with the controller, communicates with the controller, for the purpose of data exchange, by means of specific predetermined protocols (e.g. Ethernet, Profinet, or Powerlink), and is connected to it. In cases in which relevant information is deposited in databanks, the databank is of course also connected to the controller such as to be able to communicate.

An exemplary embodiment of the invention is described hereinafter on the basis of the schematic drawings. These show:

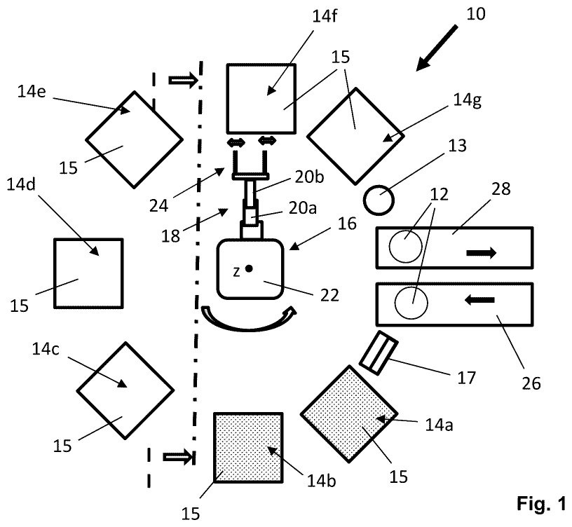

FIG. 1A view from above onto a container treatment system for kegs, with five treatment modules,

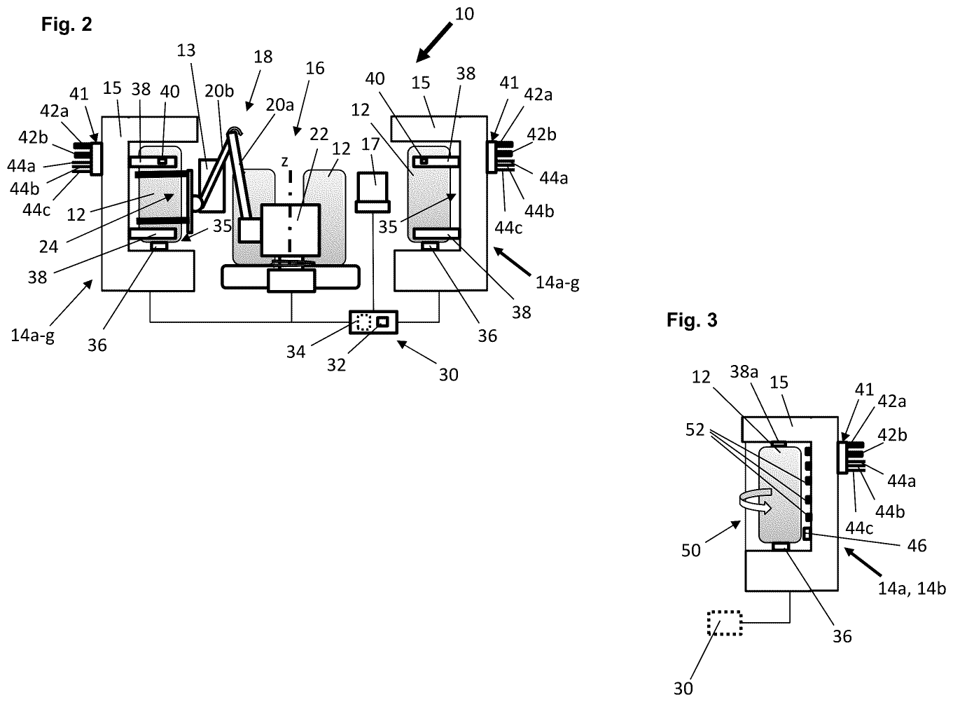

FIG. 2 a view II-II from FIG. 1, omitting the treatment modules arranged at an angle, and

FIG. 3 a treatment module with an additional device for the exterior cleaning of the keg, and

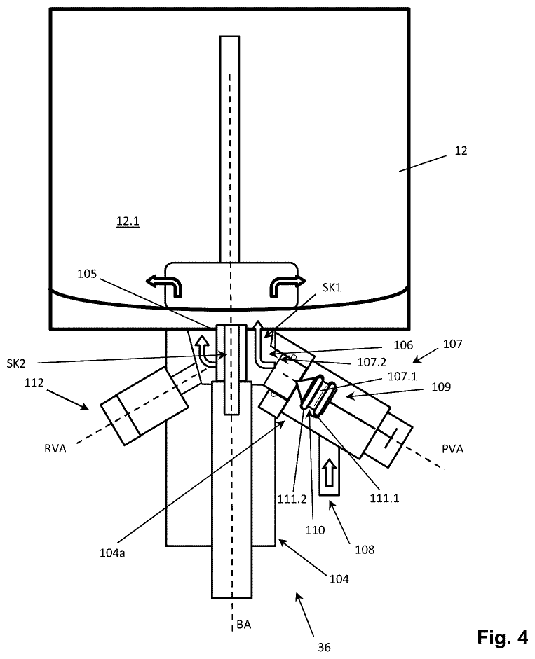

FIG. 4 an exemplary representation of a treatment head for the interior cleaning and filling of a keg.

FIGS. 1 and 2 show a system 10 for the treating of kegs 12, which can also be designated as a keg treatment system 10 for the cleaning and filling of kegs 12, which comprises seven container treatment modules 14a-14g, which are arranged in a circle around a loading device 16 in the form of a loading robot 16. The loading robot 16 comprises a basic body 22, which can be rotated about a vertical axis z, and which carries a gripper arm 18 which is movable through several degrees of freedom. The gripper arm 18 comprises a first arm section 20a for securing to the basic body 22 of the loading robot 16, a second arm section 20b, arranged in a jointed connection to the first arm section 20a, arranged at the free end of which in turn is a gripper 24, which is capable of gripping a keg 12 from a delivery belt 26 and delivering it to any of the container treatment modules 14a-14g, as well as taking it from there and delivering it to a discharge belt, from which the treated kegs 12, in particular cleaned and filled, are further transported away. As an alternative or in addition to the loading robot 16, a signal device 17 in the form of a display is arranged, on which it is displayed which treatment procedure is being or will be carried out at the individual treatment modules 14a-g. If the loading robot 16 is not provided, the signal device 17 serves to guide the operator person, in order to ensure optimum cleaning and filling at the treatment modules 14a-g.

Also arranged in the travel path of the gripper arm 18 of the loading robot 16 is a function device 13, such as a printer, a capper, a cap remover, a label applier, or the like. In this way it is possible, without substantial changes to the travel path of the gripper arm 18, for additional treatment steps to be integrated into the treatment sequence, such as, for example, the application of a label, printing, or the fitting and removal of a cap onto and from the fitting of the keg 12.

FIG. 2 also shows a common controller 30, which is connected both to the signal device 17, the loading robot 16, and also to each treatment module 14a-g. As an alternative, it is possible for decentralised controllers to be used, which are networked to one another. The controller 30 contains a work planning memory 32 for cleaning and filling orders which are to be carried out by the treatment system 10, and a computer module 34, which is configured such as to control in an optimised manner, on the basis of the filling orders present in the work planning memory 32, both the signal device 17 and the loading robot 16, as well as each of the treatment modules 14a-14g.

All the treatment modules 14a-14g are preferably provided with a treatment head 36, configured as a combined cleaning/filling head and capable of cleaning the keg 12 internally as well as filling it. As well as this combined cleaning and filling option for each treatment module 14a-14g, the first two treatment modules 14a and 14b additionally have an exterior cleaning function (FIG. 3), which allows the kegs 12 also to be cleaned on the outside, i.e. for the outer wall of the keg 12 to be cleaned. As an alternative, provision can be made for the first two treatment modules 14a and 14b to have only the exterior cleaning function, while all the other treatment modules 14c-14g have the cleaning and filling function due to the combined cleaning/filling head 36.

In this exemplary embodiment, the loading robot 16 can be rotated about a central axis z, which is located in particular in the centre of the treatment modules 14a-14g arranged in a circle. This is advantageous, because the distance interval from each treatment module 14a-14g and the loading robot 16 is identical, which simplifies the calculation and optimisation of the delivery and removal paths. As an alternative, it is also possible for the loading robot 16 to be moved on a trolley, and so arrange the treatment modules 14a-14g left and right in a row. In this situation, for better utilisation of space, the treatment modules 14a-14g are arranged above one another or offset above one another.

Each treatment module 14a-g has a keg receiver 35 and a holding device 38 for the keg 12, preferably configured such as to grip around the keg, in which it is optionally also possible for a temperature detection device 40 to be arranged, configured as a temperature sensor. The temperature sensor 40 can also be located separated from the holding device 38, which allows the position to be freely selectable. Optionally, several temperature sensors 40 can also be arranged at different locations in order to detect the temperature and temperature curves. Instead of a temperature sensor, or additionally to it, a heat imaging camera can also be used.

As an alternative, in further embodiments, the holding of the kegs 12 in the treatment module 14a-g can also be applied from above onto the base of the keg 12, as is shown, for example, on the basis of the treatment modules 14a, 14b in FIG. 3. In this case, a base holding device 38a for the keg is provided in the treatment module 14a, 14b. The keg 12 is held in its identical cleaning and filling position in an upside-down position in the keg receiver 35 of the treatment module 14a-g, such that the fitting of the keg 12 can be connected from below to the treatment head 36, configured as a combined cleaning/filling head.

Each treatment module 14a-14g is or can be connected via an interface 41, which can also be designated as a supply interface 41, with connections 42a,b for connecting to several product lines for different filling products. For example, these can open into tanks for different filling products. This makes it possible for filling of different filling products to take place in the system 10 or treatment system by means of the different treatment modules 14a-14g simultaneously, overlapping, or successively. As well as this, after the treatment of each keg 12, the filling product of a treatment module 14a-14g can be changed after each filling of a keg 12. This considerably increases the flexibility of the system 10 or treatment system.

By means of the interface 41, which preferably additionally comprises connections 44a-c for the connection of media lines, in particular connections 44a-c for connecting a water/water vapour or steam line, a tension gas line, or a cleaning medium line, each treatment module 14a-14g is additionally connected to media lines, in the present case by means of the connection 44a to a cold water line, by means of the connection 44b to a water vapour or steam line, and 14 by way of the connection 44c to a cleaning medium line 44c. It is of course also possible for other lines, such as, for example, a tension gas line, a CO₂ line, etc., to be connected to the interface 41 or supply interface.

A waste water line of the treatment modules 14a-14g is not represented in the drawing. By means of the interface 41 or supply interface 41 of each treatment module 14a-14g, it is possible for the different treatment stages to be carried out simultaneously in the container treatment system 10, such as cleaning and filling, as well as filling with different filling products. Even with a relatively small system 10, with only two container treatment modules 14a-14g, this allows for a great deal of flexibility, since both the controlling by means of the controller 30 of the different treatment processes, such as filling and interior cleaning, as well as the filling of different filling products, corresponding to the filling orders present in the work plan memory 32, are possible even for very small batches, down to one single keg 12. This treatment system 10 is therefore very well-suited for the dynamic treatment of kegs 12 in smaller and medium-sized filling operations.

Optionally, the first two container treatment modules 14a and 14b have a device for exterior cleaning of the keg 12, such as is shown in FIG. 3. Accordingly, the keg receiver 35 of the first two container treatment modules 14a,b is enclosed, for example, by a Plexiglas housing 50, a metal housing, or glass covering, in order to allow for the spraying of the outer wall with a high-pressure jet and/or steam pressure jet without impairing the surrounding area. For this purpose, the keg receiver 35 is surrounded in particular by a cladding, such as of stainless steel, or a Plexiglas housing 50. Arranged at the frame 15 of the first two treatment modules 14a,b are spray nozzles 52, such as high-pressure spray nozzles. In addition, the keg 12 is held by a base holding device 38a from above and such as to rotate, so that all sides of the outer wall of the keg 12 can be 9 effectively cleaned. The Plexiglas housing 50 can be moved by means of the controller 30 between a release position and a working position, and the spray 11 nozzles 52 can likewise be actuated by the controller 30. The first two container treatment modules 14a,b can comprise this outer wall cleaning option either together with the already existing filling and interior cleaning option of the cleaning/filling heads 36, or the first two treatment modules 14a and b are configured only for exterior cleaning, and the interior cleaning and filling are then carried out after the exterior cleaning in the five further treatment modules 14c-14g.

In addition to the temperature sensor 40, it is also possible, for example, for a reader device 46 to be arranged at the treatment module 14a-g or at another part of the treatment system 10. The reader device 46 serves in particular to read a machine-readable data carrier of the keg 12. The individual data of the keg 12 which is read in, such as the filling location and the filling product, can be detected, for example, directly or indirectly from its degree of dirt contamination. This data of the keg 12 can, moreover, be stored in a memory of the controller 30, and used, for example, for reference purposes, such as at which customer the keg 12 was last located, how much is the empty weight, which product was last filled, how long the keg 12 was with the customer, how long it was transported or stored, etc. By way of this data, it also becomes possible in future to draw conclusions about the degree of dirt contamination, and use this, by way of the controller, to adjust an individual cleaning time for each keg 12.

The dirt contamination can also be detected, i.e. alternatively or additionally, by measuring the weight of the keg. These features allow the controller 30 to adjust the duration of the cleaning process individually for every single keg 12.

Alternatively, the dirt contamination can also be detected by means of a vibration sensor located on the outer wall of the keg, since the degree of contamination is reflected in the vibration behaviour of the keg.

In its commands regarding the cleaning and filling orders, the controller 30 can also take account of the individual cleaning times of different treatment modules 14a-14g, such as are acquired by means of the reader device 46. In this way, highly effective and rapid container treatment can be provided, including exterior cleaning and filling, for small and medium-sized filling operations.

With regard to FIG. 4, a treatment head 36 is now described solely by way of example, on the basis of a possible embodiment shown only as an example, such as can be used, for example, in at least one of the treatment modules 14a-g. The preferred treatment head 36 shown by way of example is a special multifunctional treatment head 36 for the interior cleaning and filling of kegs 12.

The treatment head 36, comprising a treatment head housing 104, comprises a plunger 105, which is at least partially accommodated in a cavity space of the treatment head housing 104, and is held in the treatment head housing 104 such as to be movable in the axial direction of a treatment head axis BA, and which can open at the displacement of the keg fitting of the keg 12 which is to be treated and is arranged in a sealing position at the treatment head 36. The cavity space in the treatment head housing 104 further forms, at least in part or at least in sections, a fluid space 106, as well as flow paths or channels SK1, SK2, which communicate in a controlled manner with the fluid space 106, and which, with the keg fitting open of a keg 12 arranged in a sealing position at the treatment head 36, can be connected in a controlled manner with the interior 12.1 of the keg 3. For example, the interior 2.1 of the keg 3 can be filled with the filling product via the first flow path or channel SK1. The second flow path or channel SK2 serves to remove in a controlled manner at least one treatment medium from the interior 12.1 of the keg 3, and/or the controlled delivery of at least one treatment medium into the interior 12.1 of the keg 12. The second flow path or channel SK2 can extend at least partially through the plunger 105.

Additionally, at the treatment head 36 media valves 107, 112 are provided which are assigned to the fluid space, and specifically a first controllable media valve 107, serving as a product valve for the controlled delivery of the filling product, which can be connected to a filling product delivery line 108, and a second controllable media valve 112, serving as a return valve. Each of the media valves 107, 112, extends along a respective valve axis, and specifically the product valve 107 along a product valve axis PVA, and the return valve 112 along a return valve axis RVA. The media valves 107, 112 connect to a respective valve housing section 104a at a transition section or valve transition section of the treatment head housing 104. The valve housing section 104a can be, for example, an integral part of the treatment head housing 104, and configured as being of one piece with it.

At least at the first controllable media valve 107, serving as a product valve, there is provided a valve body 107.1 which is at least partially accommodated in the valve housing section 104a, or at least partially projecting into the valve housing section 104a, and which can be moved in the direction of the product valve axis PVA. An actuator drive is provided for the movement of the valve body 107.1 along the product valve axis PVA. Formed in the interior in the valve housing section 104a is a valve seat 107.2, against which the valve body 107.1 is in sealing contact in the region of its front valve body end, at least in one of its extreme positions, namely in a closed position or a first closed valve position.

In its other extreme position, shown in FIG. 4, namely its open position, the valve body 107.1 is located at a distance from the valve seat 107.2, as a result of which a flow path is cleared for the filling product, inasmuch as, in this valve position, the filling product delivery line 108 is fluidly connected to the fluid space 106 and, connected to this, the first flow path or channel SK1. The controlling and/or monitoring of the media valves 107, 112 is carried out by the control and/or monitoring unit, which, among other tasks, also controls and monitors the valve settings and the switching of the valves.

With the multifunctional treatment head 36 shown, the product valve 107 comprises a multiple seal arrangement 109 for the multiple sealing of the filling product delivery line 108 against the fluid space 106, in order to ensure that a secure separation is guaranteed between the filling product and cleaning media or cleaning means. By means of the multiple seal arrangement 109, which in the example represented is formed by a double-seat valve or double-seal leakage valve, and a first sealing element 111.1 as well as a second sealing element 111.2, a security or leakage space 110 is formed, which in the first closed valve position of the product valve forms a separated intermediate space between the fluid space 106 and the filling product delivery line 108, and thereby separates and seals the filling product delivery line 108 and the fluid space 106 reliably and preferably entirely from one another, and preferably sealed against one another.

The cleaning and filling process are described hereinafter on the basis of an exemplary sequence in basic details, such as can be carried out in an exemplary treatment module 14a-g which is equipped with the exemplary treatment head 36 described.

A keg 12 which is to be treated, empty or still containing a residual amount of a filling product, is introduced into the treatment module 14a-g, and positioned there in such a way that the keg 12 comes with its keg fitting into a sealing position with the treatment head 36 and is pressed against it. In order to set the internal cleaning process in motion, the keg fitting 2 is opened by means of the plunger 105, such that the individual interior cleaning steps can be carried out. During the interior cleaning, in each of the individual sequential cleaning steps, in each case a cleaning medium is introduced via the treatment head 36, and removed again via the second controllable media valve 112 of the treatment head 36, serving as a return valve. During the entire interior cleaning process, the product valve 107, connected to the filling product delivery line 108, is held in its closed valve position, in which the fluid space 106 and the filling product delivery line 108 are kept securely and double-sealed separated from one another by way of the security or leakage space 110, formed by the multiple seal arrangement 109.

After the interior cleaning steps for cleaning the interior 12.1, the first media valve 107 is brought in a controlled manner into a middle valve position, taking effect as an intermediate or flushing position, in order to carry out a head flushing or dead space flushing with the flushing of the security or leakage space 110. By means of a flushing device, preferably provided at the security or leakage space 110 (but not represented in the Figures), in particular by means of a flushing valve, also designated as a satellite valve, and/or by way of a controlled discharge to the outside, the flushing and secure emptying of the security or leakage space 110 can be carried out in a controlled manner, in order to hold this open or closed as required. After this flushing of the head or dead space, the first media valve 107 for the actual filling of the keg 12 with filling product is brought into the filling position, and filling product is introduced until, by closing the first media valve 107, the filling step is stopped again on reaching the desired filling level.

The controller 30 is preferably formed by a microprocessor control system.

It is clear to the person skilled in the art that the exemplary embodiment represented is not to be understood as restrictive, but rather that the invention can be put into effect within the entire scope of protection of the appended claims.

### REFERENCE NUMBER LIST

10 System for treating kegs/keg treatment system
12 Keg
13 Function device
14a-g Treatment module with combined cleaning and filling function
14a,b Treatment module with additional exterior cleaning function
15 Frame of the treatment module
16 Loading device/loading robot
17 Signal device
18 Gripper arm of the robot
20a First arm section
20b Second arm section
22 Basic body of the loading robot, rotatable about a vertical axis of rotation z
24 Gripper of the loading robot
26 Delivery belt
28 Discharge belt
30 Controller
32 Work plan memory
34 Computer module
35 Receiver—keg receiver of the treatment module
36 Treatment head
38 Circumferentially engaging holding device for the keg
38a Base holding device for the keg
40 Temperature detection device/temperature sensor
41 Interface/supply interface
42a,b Connections for filling product lines
44a-c Connections for media lines
44a Connection for water line
44b Connection for water vapour or steam line
44c Connection for cleaning medium line
46 Reader device for keg data
50 Plexiglas housing
52 Spray nozzle for exterior cleaning
Z Vertical axis of rotation of the loading robot

1-20. (canceled)

21. A system for treating kegs, the system comprising:
at least two treatment modules, each of the at least two treatment modules having
a keg receiver for receiving at least one keg during the treatment,
a treatment head for filling the keg, and
at least one interface for a discharge line and for at least one filling product line and/or at least one cleaning medium line;
a controller for controlling the treatment modules;
at least one treatment module of the at least two treatment modules being connected by the interface to a filling product source providing a first filling product;
at least one other treatment module of the at least two treatment modules being connected by the interface to a filling product source providing a second filling product; and
the controller being configured to actuate and control the at least two treatment modules for simultaneous and/or time-offset filling with different filling products.

22. The system according to claim 21, further comprising a loading device connected to the controller for delivering and removing the kegs to and from the treatment modules.

23. The system according to claim 22, wherein the controller is configured to control the loading device, and the loading device is configured to move kegs filled with different filling products out of the treatment modules onto a transport pallet or a transporter.

24. The system according to claim 22, wherein the controller has a work plan memory for filling and/or cleaning commands which are to be carried out, and the controller has a computer module configured to control the treatment modules and the loading device based on the filling and/or cleaning commands.

25. The system according to claim 24, wherein the computer module of the controller is configured to control the treatment modules and the loading device to process commands based on at least one optimization criteria selected from the group consisting of time optimization, optimization of the filling and/or cleaning capacity, energy optimization, optimization of the actuation paths of the loading device, and customer-specific grouping (e.g. on pallets) without buffering and/or resorting.

26. The system according to claim 21, wherein the keg receiver of at least one of the treatment modules is configured to receive one single keg.

27. The system according to claim 21, wherein the at least two treatment modules are configured for the treatment of different kegs, at least one of the treatment modules is configured for the treatment of kegs of a first type and/or of a first size, and at least one other of the treatment modules is configured for the treatment of kegs of a second type and/or a second size.

28. The system according to claim 21, wherein the treatment head of at least one treatment module is configured both for the filling as well as for the interior cleaning of kegs.

29. The system according to claim 21, wherein at least one of the treatment modules has a device for the external cleaning of kegs.

30. The system according to claim 21, wherein at least one of the treatment modules has at least one external cleaning module for the external cleaning of one or more kegs.

31. The system according to claim 30, wherein the external cleaning module and the respective at least one treatment module each have an interface with connections to a water line, water vapor, or steam line; a tension gas line; and/or at least one cleaning medium line.

32. The system according to claim 21, wherein at least one of the treatment modules contains a temperature detection device configured to measure an outer wall temperature of the keg during the treatment of the keg in the treatment module.

33. The system according to claim 21, wherein the keg receiver is configured for the static reception of the keg during the treatment of the keg.

34. The system according to claim 21, further comprising a signal device for guiding operating personnel in treatment activities to be carried out at the treatment modules.

35. The system according to claim 34, wherein the signal device has at least one visual indicator, at least one display, and/or at least one audible signaler.

36. The system according to claim 21, further comprising at least one identification device, connected to the controller; and
wherein the identification device is configured for identifying the keg which is to be treated and to read information deposited on data carriers assigned to the kegs which are to be treated, and the controller is configured to control the system in an optimized manner based on the information read by the identification device.

37. The system according to claim 36, wherein the controller is configured to optimize the actuation of the treatment modules based on a at least one criteria selected from the group consisting of:
cleaning parameters for the cleaning of the identified kegs;
filling product for filling the identified kegs;
filling parameters for filling the identified kegs; and
origin and/or further destination of the identified kegs.

38. The system according to claim 36, wherein the identification device is a reader with a reader unit configured to read the information deposited on the data carriers assigned to the kegs with electromagnetic waves.

39. The system according to claim 38, wherein the reader device has several reader units arranged at or in at least one treatment module.

40. The system according to claim 38, wherein the reader device is a combined writing and reading device, and is configured to write information onto the data carriers and/or into a databank.
